(19) United States
(12) Patent Application Publication
(10) Pub. No.: US 2025/0104483 A1
(43) Pub. Date: Mar. 27, 2025

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Teruyoshi FUJIWARA, Toyota-shi (JP); Iwao NITTA, Nagoya-shi (JP); Ryota SUZUKI, Ikeda-shi (JP)

(73) Assignee: TOYOTA JIDOSHA KABUSHIKI KAISHA, Toyota-shi (JP)

(21) Appl. No.: 18/808,454

(22) Filed: Aug. 19, 2024

(30) Foreign Application Priority Data
Sep. 22, 2023 (JP) 2023-159167

(51) Int. Cl. G06V 40/50; G06V 10/12; G06V 40/16

(52) U.S. Cl. CPC G06V 40/50; G06V 10/12; G06V 40/172

(57) ABSTRACT

A controller is provided which is configured to perform: acquiring user identification information that is identification information of a user of a vehicle and an authentication face image that is an image of a face of the user for authentication; acquiring vehicle identification information that is identification information of the vehicle associated with the user identification information; acquiring information on an attribute of the vehicle associated with the vehicle identification information; and generating a processed authentication face image by processing the authentication face image according to the information on the attribute of the vehicle.

### CROSS REFERENCE TO THE RELATED APPLICATION

This application claims the benefit of Japanese Patent Application No. 2023-159167, filed on Sep. 22, 2023, which is hereby incorporated by reference herein in its entirety.

### BACKGROUND

### Technical Field

The present disclosure relates to an information processing apparatus and an information processing method.

### Description of the Related Art

It is known that image data of the faces of workers who are allowed to enter a security area is stored in advance as registration information to perform face authentication processing (see, for example, Patent Literature 1).

### CITATION LIST

### Patent Literature

Patent Literature 1: Japanese Patent Application Laid-Open Publication No. 2022-137959

### SUMMARY

An object of the present disclosure is to improve the accuracy of face authentication.

### Solution to Problem

One aspect of the present disclosure is directed to an information processing apparatus including a controller configured to perform:
acquiring user identification information that is identification information of a user of a vehicle and an authentication face image that is an image of a face of the user for authentication;
acquiring vehicle identification information that is identification information of the vehicle associated with the user identification information;
acquiring information on an attribute of the vehicle associated with the vehicle identification information; and
generating a processed authentication face image by processing the authentication face image according to the information on the attribute of the vehicle.

Another aspect of the present disclosure is directed to an information processing method for causing a computer to perform:
acquiring user identification information that is identification information of a user of a vehicle and an authentication face image that is an image of a face of the user for authentication;
acquiring vehicle identification information that is identification information of the vehicle associated with the user identification information;
acquiring information on an attribute of the vehicle associated with the vehicle identification information; and
generating a processed authentication face image by processing the authentication face image according to the information on the attribute of the vehicle.

A further aspect of the present disclosure is directed to an information processing apparatus including a controller configured to perform:
acquiring a user's face image that is an image generated by photographing a user who is on board a vehicle with a camera disposed outside the vehicle;
acquiring vehicle identification information that is identification information of the vehicle;
acquiring, at the time of authentication, user identification information that is identification information of the user associated with the vehicle identification information;
acquiring a processed authentication face image which is an image of a face of the user associated with the user identification information, and which is an image of the face of the user processed so as to reflect an attribute of the vehicle specified from the vehicle identification information;
performing authentication of the user by comparing the user's face image with the processed authentication face image; and
performing processing associated with the user when the authentication of the user is successful.

A still further aspect of the present disclosure is directed to an information processing method for causing a computer to perform information processing in the information processing apparatus, a program for causing a computer to perform information processing in the information processing apparatus, and a storage medium storing the program in a non-transitory manner.

### Advantageous Effects of Invention

According to the present disclosure, it is possible to increase the accuracy of face authentication.

### BRIEF DESCRIPTION OF THE DRAWINGS

FIG. 1 is a view illustrating a schematic configuration of a system according to an embodiment;

FIG. 2 is a view illustrating an outline of the processing of the system according to the embodiment;

FIG. 3 is a block diagram schematically illustrating an example of a hardware configuration of each of a center server, a user side server, an association management server, a vehicle ID server, and a payment server which together constitute the system according to the embodiment;

FIG. 4 is a block diagram schematically illustrating an example of a hardware configuration of each of a user terminal and an in-vehicle terminal according to the embodiment;

FIG. 5 is a diagram schematically illustrating an example of a software configuration of the center server according to the embodiment;

FIG. 6 is a diagram illustrating an example of table configurations of a user information DB, an authentication face image DB, a processed authentication face image DB, and a vehicle attribute DB according to the embodiment;

FIG. 7 is a diagram schematically illustrating an example of a software configuration of the user side server according to the embodiment;

FIG. 8 is a diagram schematically illustrating an example of a software configuration of an in-vehicle device according to the embodiment;

FIG. 9 is a diagram schematically illustrating an example of a software configuration of the user terminal according to the embodiment;

FIG. 10 is a flowchart of user registration processing in the center server according to the embodiment;

FIG. 11 is a flowchart of processing of providing a processed authentication face image in the center server according to the embodiment;

FIG. 12 is a flowchart of face authentication processing in the user side server according to the embodiment;

FIG. 13 is a diagram illustrating an example of a table configuration of a processed authentication face image DB according to an embodiment; and

FIG. 14 is a flowchart of processing of providing a processed authentication face image in the center server according to the second-mentioned embodiment.

### DESCRIPTION OF THE EMBODIMENTS

According to a face authentication system, a subject (person) can be authenticated even when the subject is far away from the system, as long as the face of the subject can be photographed by a camera. Therefore, face authentication makes it possible to authenticate the subject in a simple and early manner. However, conventional face recognition systems have the following problems.

That is, in recent years, with advances in machine learning technology, the number of situations in which face authentication can be performed has been increasing. In addition, there are an increasing number of situations, such as for example drive-throughs, where authentication of a subject is recommended while the subject is still in a vehicle, which is increasing the need for face authentication. Therefore, it is assumed that a picture of a subject who gets in a vehicle is taken from outside the vehicle, and a face image of the subject thus obtained is used to authenticate the subject. The system is assumed to be configured to perform face authentication by comparing a previously obtained authentication face image with the face image obtained at the time of authentication. In this case, the authentication face image is basically obtained by taking a picture of the subject at an optional timing when the subject is not in the vehicle (e.g., the subject takes a picture of himself or herself with a portable or mobile terminal). On the other hand, the face image obtained at the time of authentication reflects components constituting the vehicle, such as for example the windshield, side glasses (windows), etc. In one example, by photographing the subject through the windshield, the face of the subject may appear a different color in the resulting face image than it actually is due to the influence of the color of the windshield. This may result in a significant discrepancy between how the subject appears in the face image obtained at the time of authentication and how the subject appears in the authentication face image, which may result in incorrect face authentication. The present disclosure solves such problems.

Therefore, an information processing apparatus, which is one of the aspects of the present disclosure, includes a controller configured to perform: acquiring user identification information that is identification information of a user of a vehicle and an authentication face image that is an image of a face of the user for authentication; acquiring vehicle identification information that is identification information of the vehicle associated with the user identification information; acquiring information on an attribute of the vehicle associated with the vehicle identification information; and generating a processed authentication face image by processing the authentication face image according to the information on the attribute of the vehicle.

The user of the vehicle is a user associated with the vehicle. The user may be the owner of the vehicle. The user identification information is information that can identify the user, and may be, for example, information on a user ID that is assigned in advance. Also, as another example, the user identification information may be information on the number of a driver's license. The authentication face image is an image obtained by photographing the face of the user in advance. The authentication face image may be an image obtained by photographing the face of the user himself or herself by using a camera attached to a terminal of the user, for example. The user identification information and the authentication face image may be registered in advance. The vehicle identification information is information that can identify the vehicle, and is, for example, information on the chassis number or the number of a vehicle registration number certificate (license plate). The vehicle identification information may be registered in advance in association with the user identification information, for example. The vehicle identification information may be associated with information on a vehicle type (model) or a vehicle name.

The information on the vehicle attribute is information associated with the vehicle identification information, and is, for example, information on the height of the vehicle (vehicle height), the size of the vehicle, the color of the windshield, the color of the side windows, the position of the wipers, the position of the sun visors, the position of the A-pillars (the pillars on both sides of the windshield), or the like. The attribute of the vehicle here refers to components that may affect an image when the user in the vehicle is photographed from the outside of the vehicle. For example, when the face of the user in the vehicle is photographed from the outside of the vehicle, its image is taken through the windshield or side glasses. The color of these glasses affects the image of the user's face. Depending on the color of the glasses, face authentication may not be correctly performed. In addition, since the position of the user's face from the ground to the user's face changes depending on the height (vehicle height) or size of the vehicle, the angle of the user's face can change when the user's face is photographed from the outside of the vehicle. In addition, it is conceivable that the wipers, the sun visors, and/or the A pillars are photographed overlapping the face of the user. Accordingly, these attributes may also affect the image of the user's face.

Therefore, the controller processes the authentication face image in accordance with the information on the attribute of the vehicle. For example, in cases where information on the color of the windshield is acquired as information on the attribute of the vehicle, the color of the windshield is reflected on the authentication face image to generate the processed authentication face image. By generating the processed authentication face image in this way, it is possible to suppress a large discrepancy between the user's appearance in the processed authentication face image and the user's appearance in the image taken from outside the vehicle at the time of authentication. Therefore, the accuracy of face authentication can be improved.

Hereinafter, embodiments of the present disclosure will be described based on the accompanying drawings. The configurations of the following embodiments are examples, and the present disclosure is not limited to the configurations of the embodiments.

### First Embodiment

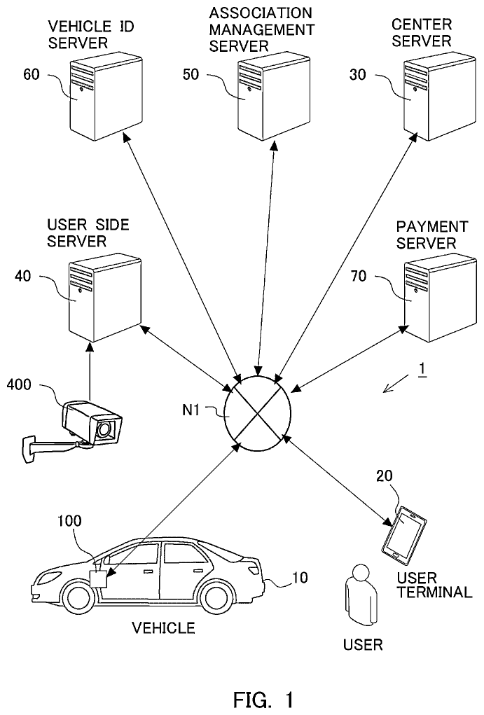

FIG. 1 is a view illustrating a schematic configuration of a system 1 according to an embodiment. In the example of FIG. 1, the system 1 includes an in-vehicle device 100 installed in a vehicle 10, a user terminal 20 possessed by a user of the vehicle 10, a center server 30, a user side server 40, an association management server 50, a vehicle ID server 60, and a payment (or settlement) server 70. The user side server 40 is connected to a camera 400 that takes pictures of the interior of the vehicle 10 from outside the vehicle 10.

The in-vehicle device 100, the user terminal 20, the center server 30, the user side server 40, the association management server 50, the vehicle ID server 60, and the payment server 70 are connected to one another by a network N1. Here, note that the network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like. FIG. 1 illustrates one vehicle 10 and one user terminal 20 by way of example, but there can be more than one of these. The in-vehicle device 100 and the user side server 40 or the camera 400 may be capable of short-range wireless communication.

The in-vehicle device 100 is a device that provides information on the vehicle 10 to the user side server 40. The user terminal 20 is a terminal capable of providing a face image of the user. The center server 30 is a server that generates an authentication face image and provides it to the user side server 40. The user side server 40 is a server that performs face authentication. The association management server 50 is a server that manages the association between the vehicle 10 and the user. The vehicle ID server 60 is a server that manages information on the vehicle 10. The payment server 70 is a server that performs payment.

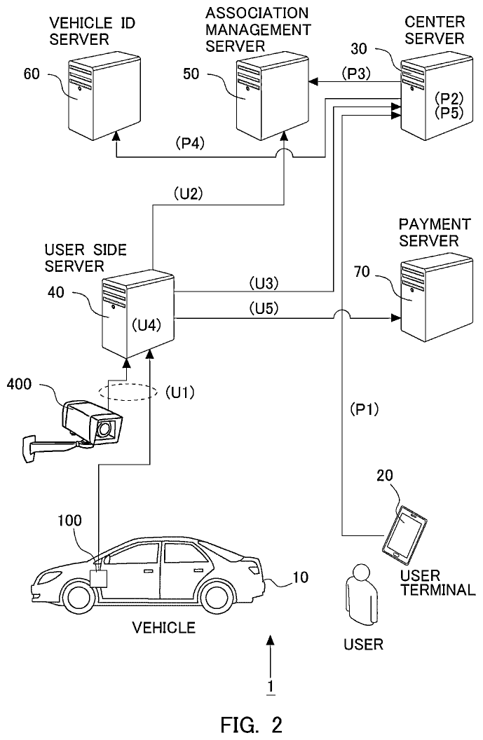

FIG. 2 is a view illustrating an outline of the processing of the system according to the embodiment. In FIG. 2, P1 through P5 are processes related to the center server 30, and U1 through U5 are processes related to the user side server 40. In P1, the user performs user registration in the center server 30 using the user terminal 20. The user requests user registration to the center server 30 via the user terminal 20. At this time, the face image associated with the user ID is transmitted to the center server 30. This face image will also be hereinafter referred to as an authentication face image. The authentication face image is, for example, an image of the face of the user taken by the user terminal 20. However, the authentication face image is not limited to this, but may be an image of the face of the user that has been taken in the past and stored in the user terminal 20 or an external server. Note that the user ID may be, for example, a number assigned by a common number system for identifying an individual in each country (e.g., My Number, Social Security Number, or Citizen Identification Number) or a motor vehicle driver's license number. The user ID is an example of the user identification information. In addition, at the time of user registration, information on payment is transmitted from the user terminal 20 to the center server 30 in association with the user ID. The information on payment is information necessary when the user uses a payment service, and includes, for example, a credit card number or a bank account number.

In P2, the center server 30 acquires and stores the user ID, the authentication face image, and information on payment from the user terminal 20. In P 3, the center server 30 requests the association management server 50 to transmit the vehicle ID associated with the user ID. The association management server 50 executes a search using the user ID, and extracts a vehicle ID associated with the user ID. Then, the center server 30 acquires the vehicle ID associated with the user ID from the association management server 50. The vehicle ID is a number unique to the vehicle 10, and is, for example, a chassis number (vehicle identification number) or a number displayed on a motor vehicle registration number certificate (license plate). This number will also be hereinafter referred to as a vehicle number. The vehicle ID is an example of the vehicle identification information.

In P4, the center server 30 requests the vehicle ID server 60 to transmit the vehicle information associated with the vehicle ID. The vehicle ID server 60 performs a search using the vehicle ID, and extracts the vehicle information associated with the vehicle ID. Then, the center server 30 acquires the vehicle information associated with the vehicle ID from the vehicle ID server 60. The vehicle information includes information that can identify the vehicle, and includes, for example, information on the vehicle type, the vehicle name, the chassis number, or the number on the motor vehicle registration number certificate (vehicle number). Note that the vehicle information may include information that can identify the height, size, windshield color, side glass color, wiper position, sun visor position, or A-pillar (pillars on both sides of the windshield) position of the vehicle. In addition, the vehicle information may also include information on the owner of the vehicle 10.

In P5, the center server 30 acquires an attribute of the vehicle 10 from the vehicle information acquired from the vehicle ID server, and processes the authentication face image so as to reflect the attribute. Thus, the center server 30 generates and stores a processed authentication face image. For example, the color of the windshield is acquired as the attribute of the vehicle 10 from the vehicle information, and the color of the windshield thus acquired is reflected in the authentication face image, thereby generating the processed authentication face image. The processed authentication face image may be generated by using a known technique. In this way, the processed authentication face image is stored in the center server 30 so as to be usable for face authentication when the user uses the vehicle 10.

In addition, in U1, the user side server 40 acquires the vehicle ID and the face image of the user. The face image of the user is obtained by the camera 400 photographing the user's face from outside of the vehicle 10. The face image acquired in this manner is hereinafter also referred to as a user's face image. Also, the vehicle ID may be acquired from the in-vehicle device 100 through communication. Moreover, as another example, when the vehicle ID corresponds to the vehicle number, the vehicle number may be acquired by analyzing an image of the vehicle 10 taken by the camera 400.

In U2, the user side server 40 inquires of the association management server 50 whether or not there is an association relationship corresponding to the vehicle ID. At this time, an inquiry may be made as to whether or not there is a valid association relationship at a target date and time. The target date and time may be a date and time at the time of the inquiry (this may be a current date and time), or may be a date and time in the past. A valid association is, for example, an association within an expiration date in cases where the association between the vehicle ID and the user ID has the expiration date. In cases where there is a valid association, the user ID associated with the vehicle ID is transmitted from the association management server 50 to the user side server 40.

In U3, in cases where there is a valid association relationship, the user side server 40 requests the center server 30 to transmit the processed authentication face image corresponding to the user ID. The center server 30 transmits the processed authentication face image corresponding to the user ID to the user side server 40. At this time, the center server 30 also transmits information on various kinds of authorities associated with the user ID to the user side server 40. The various kinds of authorities are, for example, authority for payment services for which the user has registered. Note that the authorities are not limited to this, and may be, for example, authority for administrative services.

In U4, the user side server 40 performs face authentication by comparing the user's face image taken by the camera 400 with the processed authentication face image. Here, known face authentication techniques can be used. The method of face authentication is not limited. In addition, image processing may also be performed by optional analytical processing (pattern matching, edge extraction, etc.). Also, a machine learning model may be used for the image processing.

In U5, when the authentication is successful, the user side server 40 executes the authority of the user. For example, the user side server 40 requests payment to the payment server 70. For example, it can be used for payment at a drive-through of a restaurant, payment of parking lot fees, or payment of toll road fees.

Here, note that the processed authentication face image may be stored in any of the center server 30 and the user side server 40. Also, the processing in the center server 30 from P2 to P5 can be performed at any timing before the processing in the user side server 40 in U4 is performed. In addition, the center server 30 may perform the processing of P2 through P5 consecutively to the processing of P1. Further, the center server 30 may also periodically refer to the association management server 50 to generate a processed authentication face image for each corresponding vehicle type. For example, when one user owns a plurality of vehicles 10, a processed authentication face image may be generated and stored for each vehicle 10.

In addition, the attribute of the vehicle 10 reflected at the time of generating the processed authentication face image may be the color of the windshield or side glasses, the position and shape of the wipers, sun visors, A-pillars, or front seats, or the vehicle height. Any component that affects the face authentication can be used as the attribute of the vehicle 10. The processed authentication face image may be generated by reflecting the attribute. The center server 30 may generate the processed authentication face image by, for example, processing the authentication face image so as to add the wipers, sun visors, A pillars, or front seats.

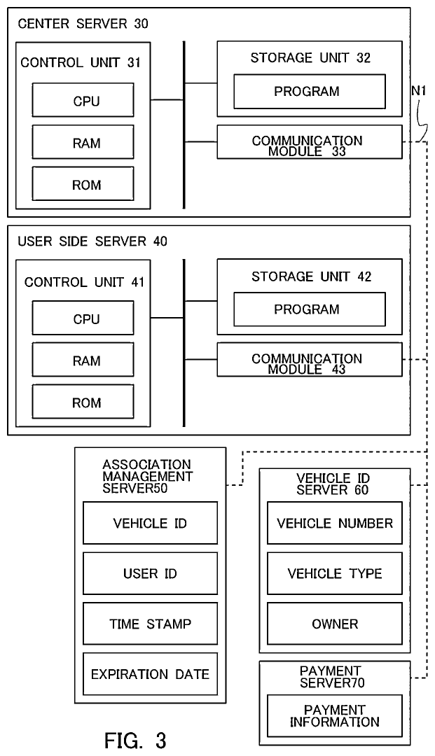

FIG. 3 is a block diagram schematically illustrating an example of a hardware configuration of each of the center server 30, the user side server 40, the association management server 50, the vehicle ID server 60, and the payment server 70, which together constitute the system 1 according to the embodiment.

The center server 30 is configured as a computer including a control unit 31, a storage unit 32, and a communication module 33. The center server 30 can be configured as a computer including a processor (CPU, GPU, etc.), a main storage device (RAM, ROM, etc.), and an auxiliary storage device (EPROM, hard disk drive, removable medium, etc.). An operating system (OS), various kinds of programs, various kinds of tables and the like are stored in the auxiliary storage device, and by executing the programs stored therein, it is possible to implement each function (software module) that meets a predetermined purpose, as described later. However, some or all of the modules may be implemented as hardware modules by means of hardware circuits such as ASICs, FPGAS, etc.

The control unit 31 is an arithmetic unit that implements the various functions of the ECU 30 by executing predetermined programs. The control unit 31 can be implemented by, for example, a hardware processor such as a CPU or the like. Also, the control unit 31 may be configured to include a RAM, a ROM (Read Only Memory), a cache memory, and the like.

The storage unit 32 is a means to store information, and is constituted by a storage medium such as a RAM, a magnetic disk, a flash memory or the like. The storage unit 32 stores programs to be executed by the control unit 31, data to be used by the programs, etc. In addition, the storage unit 32 stores various kinds of information. Details will be described later.

The communication module 33 is a communication interface for connecting the center server 30 to a network. The communication module 33 may be configured to include, for example, a network interface board, a wireless communication interface for wireless communication, and the like. The center server 30 can perform data communication with other computers (e.g., other server devices, each user terminal 20 or the like) via the communication module 33.

Here, note that the specific hardware configuration of the center server 30 can be changed such that some of its components can be omitted, replaced, or added as appropriate, depending on its implementation. For example, the control unit 31 may include a plurality of hardware processors. The hardware processors may be composed of microprocessors, FPGAs, GPUs, or the like. Also, the center server 30 may be composed of a plurality of computers. In this case, the hardware configuration of each computer may be the same or different from each other.

The user side server 40 is configured as a computer including a control unit 41, a storage unit 42, and a communication module 43. The user side server 40 can be configured as a computer including a processor (CPU, GPU, etc.), a main storage device (RAM, ROM, etc.), and an auxiliary storage device (EPROM, hard disk drive, removable medium, etc.). An operating system (OS), various kinds of programs, various kinds of tables and the like are stored in the auxiliary storage device, and by executing the programs stored therein, it is possible to implement each function (software module) that meets a predetermined purpose, as described later. However, some or all of the modules may be implemented as hardware modules by means of hardware circuits such as ASICs, FPGAs, etc. The control unit 41, the storage unit 42, and the communication module 43 of the user side server 40 have the same configurations as the control unit 31, the storage unit 32, and the communication module 33 of the center server 30, and thus descriptions thereof are omitted. The camera 400 is connected to the user side server 40, and this camera 400 is controlled by the control unit 41. The camera 400 is disposed in advance at a position where it can take an image of the driver of the stopped vehicle 10. The camera 400 takes an image by using an imaging element such as a CCD (Charge Coupled Device) image sensor, a CMOS (Complementary Metal Oxide Semiconductor) image sensor or the like.

The association management server 50, the vehicle ID server 60, and the payment server 70 can be configured as computers similar to the center server 30. The association management server 50 is a device that provides information on an association between the vehicle ID and the user ID, a time stamp of this association, and an expiration date of this association via the network N1. Therefore, the association management server 50 stores information on each of the vehicle ID, the user ID, the time stamp, and the expiration date in association with each other. The time stamp is, for example, the date and time when the user ID and the vehicle ID are associated with each other. The expiration date is the expiration date of the association between the user ID and the vehicle ID. The association management server 50 is managed by a business operator or a government agency that is neutral with respect to the administrator of the center server 30 and the administrator of the user side server 40. The information stored in the association management server 50 may be provided by the user via the user terminal 20 or may be provided by the center server 30, for example.

The vehicle ID server 60 is a device that provides information on each of the vehicle number, the vehicle type, and the owner of the vehicle 10, which are associated with the vehicle ID, via the network N1. Therefore, the vehicle ID server 60 stores information on each of the vehicle ID, the vehicle number, the vehicle type, and the owner of the vehicle 10 in a mutually associated manner. The vehicle ID server 60 is managed by a business operator or administrative agency that is neutral to the administrator of the center server 30 and the administrator of the user side server 40. The vehicle ID server 60 may be a server managed by an administrative agency that issues a license plate, for example. When the user registers the vehicle 10, a license plate is issued, and information on the number (vehicle number) of the license plate, the vehicle type, and the owner may be stored in the vehicle ID server 60.

The payment server 70 is a device that performs payment processing based on a request for payment. The payment server 70 is managed by, for example, a credit card company. As another example, the payment server 70 may be a server that manages electronic money or points, or a server that manages bank deposits. The payment server 70 stores payment information. The payment information may include, for example, information on the association between the user ID and the credit card number.

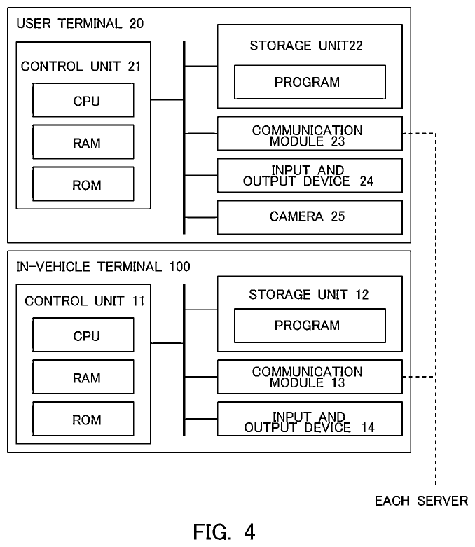

Next, FIG. 4 is a block diagram schematically illustrating an example of a hardware configuration of each of the user terminal 20 and the in-vehicle device 100 according to the present embodiment.

The user terminal 20 is a small computer such as, for example, a smart phone, a mobile phone, a tablet terminal, a personal information terminal, a wearable computer (a smart watch or the like), a personal computer (PC), etc. The user terminal 20 is configured to include a control unit 21, a storage unit 22, a communication module 23, an input and output device 24, and a camera 25.

The user terminal 20, similar to the center server 30, can be configured as a computer having a processor (CPU, GPU, etc.), a main storage device (RAM, ROM, etc.), and an auxiliary storage device (EPROM, hard disk drive, removable medium, etc.). However, some or all of the functions (software modules) may be implemented as hardware modules by means of hardware circuits such as ASICs, FPGA, etc.

The control unit 21, the storage unit 22, and the communication module 23 of the user terminal 20 have the same configurations as the control unit 31, the storage unit 32, and the communication module 33 of the center server 30, and hence, the description thereof will be omitted.

The input and output unit 24 is a means to receive an input operation performed by the user and presents information to the user. Specifically, the input and output device 24 includes a device for input such as a mouse, a keyboard or the like and a device for output such as a display, a speaker or the like. The input and output device 24 may be integrally configured with, for example, a touch panel display. The camera 25 takes an image by using an imaging element such as a CCD (Charge Coupled Device) image sensor, a CMOS (Complementary Metal Oxide Semiconductor) image sensor or the like.

Here, note that the specific hardware configuration of the user terminal 20, similar to the center server 30, can be changed such that some of its components can be omitted, replaced, or added as appropriate, depending on its implementation.

Then, the in-vehicle device 100 is a computer installed in the vehicle 10, such as an ECU (Electronic Control Unit), a DCM (Data Communication Module), a head unit, or a navigation system. The in-vehicle device 100 is configured to include a control unit 11, a storage unit 12, a communication module 13, and an input and output device 14. The control unit 11, the storage unit 12, the communication module 13, and the input and output device 14 of the in-vehicle device 100 are the same as the control unit 21, the storage unit 22, the communication module 23, and the input and output device 24 of the user terminal 20, and thus, the description thereof will be omitted.

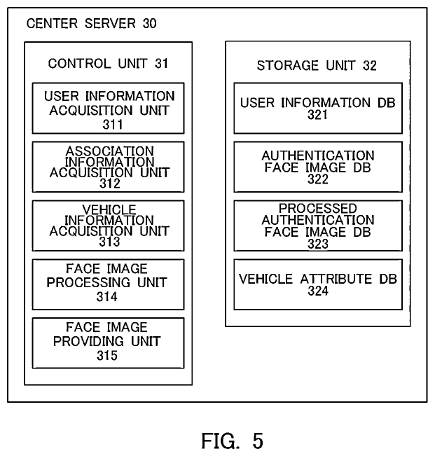

FIG. 5 is a diagram schematically illustrating an example of a software configuration of the center server 30 according to the embodiment. The control unit 31 is configured to include software modules of a user information acquisition unit 311, an association information acquisition unit 312, a vehicle information acquisition unit 313, a face image processing unit 314, and a face image providing unit 315. Each software module may be implemented by executing a program stored in the storage unit 32 by means of the control unit 31 (CPU). Note that the information processing performed by the user information acquisition unit 311, the association information acquisition unit 312, the vehicle information acquisition unit 313, the face image processing unit 314, and the face image providing unit 315, which will be described below, is synonymous with the information processing performed by the control unit 31.

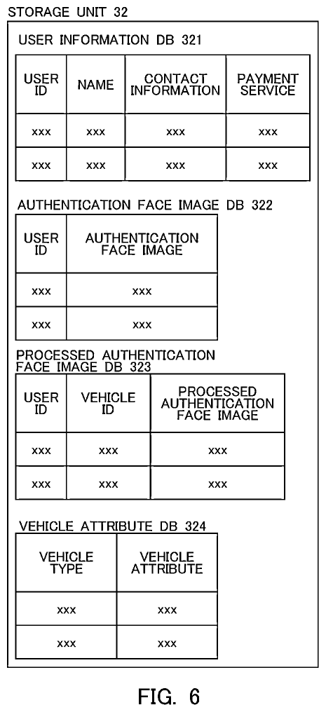

The storage unit 32 of the center server 30 stores a user information database 321 (hereinafter referred to as a user information DB 321), an authentication face image database 322 (hereinafter referred to as an authentication face image DB 322), a processed authentication face image database 323 (hereinafter referred to as a processed authentication face image DB 323), and a vehicle attribute database 324 (hereinafter referred to as a vehicle attribute DB 324). The user information DB 321, the authentication face image DB 322, the processed authentication face image DB 323, and the vehicle attribute DB 324 are built by a program of a database management system (DBMS) that is executed by the processor of the center server 30 to manage the data stored in the auxiliary storage device. These databases are, for example, relational databases. FIG. 6 is a diagram illustrating an example of table configurations of the user information DB 321, the authentication face image DB 322, the processed authentication face image DB 323, and the vehicle attribute DB 324 according to the embodiment. Details will be described later.

The user information acquisition unit 311 is configured to receive user information and an authentication face image transmitted from the user terminal 20 of the user, and to perform the processing of storing the user information and the authentication face image in the user information DB 321 and the authentication face image DB 322. As illustrated in FIG. 6, the user information DB 321 stores user IDs, the names of users, the contact information of the users, and information on payment services. The user information of the user is associated with the user ID thereof. The user ID may be, for example, the number of a motor vehicle driver's license. The contact information of the user may include an address, a phone number, an SNS account, and an email address of the user. The information on the payment services of the user is information on the association between the user and the payment services, and includes information on the payment desired by the user at the time of payment (e.g., a credit card number). The user information is registered in advance in the center server 30 by the user via the user terminal 20. As illustrated in FIG. 6, the authentication face image DB 322 stores the authentication face image in association with the user ID. The authentication face image is the face image of the user transmitted from the user terminal 20 together with the user information, and is, for example, the face image captured by the user himself or herself with the camera 25 of the user terminal 20. The user information acquisition unit 311 stores the authentication face image received from the user terminal 20 in the authentication face image DB 322 in association with the user ID. As another example, the authentication face image DB 322 may store information on locations where the authentication face images are stored.

The association information acquisition unit 312 requests the association management server 50 to perform a search using the user ID. Then, the association management server 50 returns to the center server 30 information (hereinafter, also referred to as association information) on each of the vehicle ID, the time stamp, and the expiration date associated with the user ID. The association management server 50 may periodically update the association between the user IDs and the vehicle IDs. The association information acquisition unit 312 stores the association information acquired from the association management server 50 in the storage unit 32.

The vehicle information acquisition unit 313 requests the vehicle ID server 60 to perform a search by the vehicle ID. This vehicle ID is the vehicle ID acquired from the association management server 50. Then, the vehicle ID server 60 returns information on each of the vehicle number, the vehicle type, and the owner of the vehicle 10 associated with the vehicle ID to the center server 30. The vehicle type is classified so that the attribute of the vehicle 10 can be determined. The information on the owner of the vehicle 10 includes, for example, information on the user ID or name.

The face image processing unit 314 generates a processed authentication face image by processing the face image acquired from the user terminal 20 according to the attribute of the vehicle 10 (hereinafter, also referred to as the vehicle attribute). As illustrated in FIG. 6, the vehicle attribute DB 324 stores, for example, relationships between vehicle types and vehicle attributes. The face image processing unit 314 extracts from the vehicle attribute DB 324 the vehicle attribute corresponding to the vehicle type acquired from the vehicle ID server 60. Then, the vehicle attribute thus extracted is reflected on the authentication face image acquired from the user terminal 20, thereby generating the processed authentication face image. For example, in the case where the color of the windshield of the vehicle 10 is stored in the vehicle attribute DB 324 as the vehicle attribute corresponding to the vehicle type, the face image processing unit 314 generates the processed authentication face image by reflecting the color of the windshield of the vehicle 10 in the authentication face image. That is, the processed authentication face image is generated so as to correspond to the image obtained by capturing the face of the user from the outside of the vehicle 10. The face image processing unit 314 associates the processed authentication face image thus generated with the vehicle ID and the user ID, and stores the processed authentication face image in the processed authentication face image DB 323. As illustrated in FIG. 6, the relationship among the user ID, the vehicle ID, and the processed authentication face image is stored in the processed authentication face image DB 323. Note that as another example, the processed authentication face image DB 323 may store information on the location where each processed authentication face image is stored.

The face image providing unit 315 provides a processed authentication face image in response to a request from the user side server 40. The request from the user side server 40 includes information on the vehicle ID, and the face image providing unit 315 extracts the processed authentication face image corresponding to the vehicle ID from the processed authentication face image DB 323, and transmits the processed authentication face image thus extracted to the user side server 40.

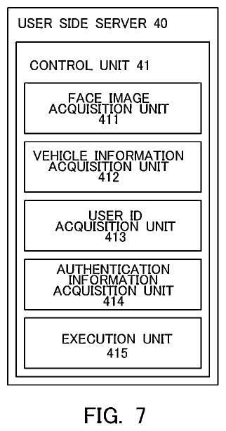

FIG. 7 is a diagram schematically illustrating an example of a software configuration of the user side server 40 according to the embodiment. The control unit 41 is configured to include the following software modules: a face image acquisition unit 411, a vehicle information acquisition unit 412, a user ID acquisition unit 413, an authentication information acquisition unit 414, and an execution unit 415. The software modules may each be implemented by executing a program stored in the storage unit 42 by means of the control unit 41 (CPU). Note that the information processing performed by the face image acquisition unit 411, the vehicle information acquisition unit 412, the user ID acquisition unit 413, the authentication information acquisition unit 414, and the execution unit 415, which will be described below, is synonymous with the information processing performed by the control unit 41.

The face image acquisition unit 411 acquires an image captured by the camera 400 when the vehicle 10 is present at a predetermined position. The camera 400 is disposed in advance at a position where the camera 400 can capture the image of the driver of the vehicle 10. The face image acquisition unit 411 constantly monitors the images captured by the camera 400, for example, and detects by image analysis that the vehicle 10 has approached the predetermined position. Then, the image of the user captured at that time is acquired as a user's face image.

The vehicle information acquisition unit 412 acquires information on the vehicle 10 existing at the predetermined position. In this case, for example, the camera 400 may be equipped with a wireless communication function, so that wireless communication between the camera 400 and the vehicle 10 may be made to obtain information on the vehicle 10 (e.g., the vehicle number). Also, as another example, the vehicle number may be read by analyzing an image of the vehicle 10 captured by the camera 400.

The user ID acquisition unit 413 requests the association management server 50 to perform a search by the vehicle ID. At this time, the user ID acquisition unit 413 inquires of the association management server 50 whether or not a valid association relationship corresponding to the vehicle ID exists at a target date and time. When a valid association relationship corresponding to the vehicle ID exists at the target date and time, the association management server 50 returns the user ID associated with the vehicle ID to the user side server 40. The user ID acquisition unit 413 stores the user ID acquired from the association management server 50 in the storage unit 42.

The authentication information acquisition unit 414 requests the center server 30 to perform a search by the user ID. The center server 30 returns information on the various kinds of authorities associated with the user ID and the processed authentication face image to the user side server 40. The various kinds of authorities include, for example, information on a payment service associated with the user ID.

When face authentication is successful and the authorities are valid, the execution unit 415 requests the payment to the payment server 70. The execution unit 415 executes face authentication by comparing the processed authentication face image acquired from the center server 30 with the user's face image acquired from the camera 400. The payment server 70 to which payment is requested is selected by the execution unit 415 based on the information on the various kinds of authorities associated with the user ID.

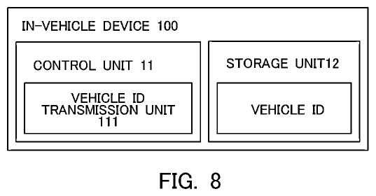

FIG. 8 is a diagram schematically illustrating an example of a software configuration of the in-vehicle device 100 according to the embodiment. In the present embodiment, the control unit 11 of the in-vehicle device 100 is configured to include a software module of the vehicle ID transmission unit 111. The software module may be implemented by executing a program stored in the storage unit 12 by means of the control unit 11 (CPU). Note that the information processing performed by the vehicle ID transmission unit 111 described below is synonymous with the information processing performed by the control unit 11.

The vehicle ID transmission unit 111 transmits a vehicle ID stored in the storage unit 12 to the user side server 40 or the camera 400 in response to a request from the user side server 40 or the camera 400. Note that in cases where the vehicle information acquisition unit 412 of the user side server 40 reads and acquires the vehicle number, the vehicle ID transmission unit 111 can be omitted.

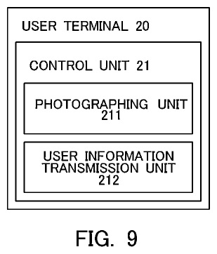

FIG. 9 is a diagram schematically illustrating an example of a software configuration of the user terminal 20 according to the embodiment. The control unit 21 of the user terminal 20 is configured to include software modules of a photographing unit 211 and a user information transmission unit 212. The software modules may each be implemented by executing a program stored in the storage unit 22 by means of the control unit 21 (CPU). Note that the information processing performed by the photographing unit 211 and the user information transmission unit 212 described below is synonymous with the information processing performed by the control unit 21.

The photographing unit 211 captures the user with the camera 25. The photographing unit 211 takes a picture when the user makes a predetermined input to the input and output device 24. At this time, the user adjusts the angle of the camera 25 so that the face of the user is captured.

The user information transmission unit 212 transmits the user information input by the user via the input and output device 24 and the user's face image captured by the photographing unit 211 to the center server 30.

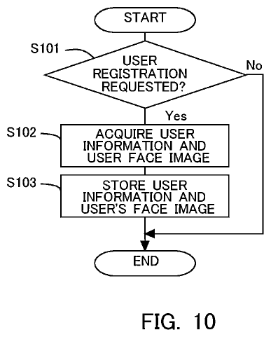

Next, user registration processing in the center server 30 will be described. FIG. 10 is a flowchart of the user registration processing in the center server 30 according to the embodiment. The processing illustrated in FIG. 10 is carried out in the center server 30 at predetermined time intervals. Note that the processing illustrated in FIG. 10 is performed by each software module of the control unit 31, but in the following flowchart, description will be given assuming that the control unit 31 performs the processing.

In step S101, the control unit 31 determines whether or not a request for user registration has been received from the user terminal 20. An application program capable of performing user registration may be installed in the user terminal 20. By using this application program, the user makes a predetermined input and takes a picture of the user's face, so that a user registration request is sent from the user terminal 20 to the center server 30. Also, as another example, the user may access from the user terminal 20 a web page on which user registration can be performed, and the user may make a predetermined input on the web page or upload an authentication face image, thereby transmitting a request for user registration from the user terminal 20 to the center server 30. When an affirmative determination is made in step S101, the processing or routine proceeds to step S102, whereas when a negative determination is made, this routine is ended.

In step S102, the control unit 31 acquires user information and an authentication face image. The user information and the authentication face image are transmitted from the user terminal 20 to the center server 30 together with a request for user registration, so that the control unit 31 acquires the user information and the authentication face image. The user information includes a user ID. In step S103, the control unit 31 performs registration processing for the user, stores the user information in the user information DB 321, and also stores the authentication face image in the authentication face image DB 322 in association with the user ID.

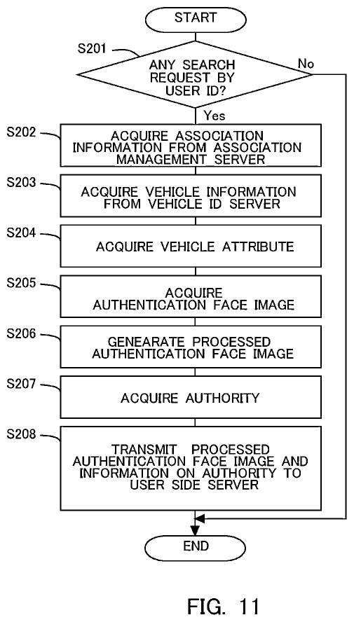

Hereafter, a description will be given of the processing of providing the processed authentication face image in the center server 30. FIG. 11 is a flowchart of the processing for providing the processed authentication face image in the center server 30 according to the embodiment. The processing illustrated in FIG. 11 is carried out in the center server 30 at predetermined time intervals. Note that the processing illustrated in FIG. 11 is performed by each software module of the control unit 31, but in the following flowchart, description will be given assuming that the control unit 31 performs the processing.

In step S201, the control unit 31 determines whether or not a request for a search by the user ID has been received from the user side server 40. This request includes a request to transmit information on the various kinds of authorities associated with the user ID and the processed authentication face image to the user side server 40. When an affirmative determination is made in step S201, the processing or routine proceeds to step S202, whereas when a negative determination is made, this routine is ended.

In step S202, the control unit 31 acquires the association information from the association management server 50. The control unit 31 requests the association management server 50 to perform a search by the user ID. This user ID is the user ID acquired by the control unit 31 from the user side server 40 in step S201. In response to this request, the association management server 50 extracts the vehicle information associated with the user ID (information on each of the vehicle ID, the time stamp, and the expiration date), and transmits it to the center server 30.

In step S203, the control unit 31 acquires the vehicle information from the vehicle ID server 60. The control unit 31 requests the vehicle ID server 60 to perform a search by the vehicle ID. This vehicle ID is the vehicle ID acquired by the control unit 31 from the association management server 50 in step S202. In response to this request, the vehicle ID server 60 extracts the vehicle information associated with the vehicle ID (information on each of the vehicle number, the vehicle type, and the owner of the vehicle 10), and transmits it to the center server 30.

In step S204, the control unit 31 extracts the vehicle attribute from the information on the vehicle type. The information on the vehicle type is included in the vehicle information acquired from the vehicle ID server 60 in step S203. The control unit 31 extracts the vehicle attribute (e.g., the color of the windshield) corresponding to the vehicle type from the vehicle attribute DB 324.

In step S205, the control unit 31 acquires the authentication face image stored in the authentication face image DB 322. The authentication face image acquired at this time is the face image received from the user terminal 20 at the time of user registration. The control unit 31 extracts, from the authentication face image DB 322, the authentication face image associated with the user ID acquired in step S201.

In step S206, the control unit 31 generates a processed authentication face image according to the vehicle attribute and the authentication face image. Specifically, the control unit 31 generates the processed authentication face image by reflecting the vehicle attribute on the authentication face image. For example, the control unit 31 processes the authentication face image obtained from the user so that it becomes the face image of the user when the user is photographed through the windshield. Known techniques can be used for this processing. The control unit 31 associates the processed authentication face image thus generated with the user ID and the vehicle ID, and stores it in the processed authentication face image DB 323.

In step S207, the control unit 31 acquires the authority of the user from the user information DB 321. In the present embodiment, information on a payment service is acquired as the information on the authority of the user. Then, in step S208, the control unit 31 transmits the processed authentication face image and the information on the user's authority to the user side server 40. The information on the user's authority transmitted at this time includes, for example, information on a payment company (credit card company) registered by the user, information on a credit card number, and the like.

Here, note that in the routine illustrated in FIG. 11, the processed authentication face image is generated by triggering a request from the user side server 40, but as another example, the processed authentication face image can also be generated following the routine illustrated in FIG. 10. For example, after the processing of step S103, the processing from step S202 to step S206 may be performed to store the processed authentication face image in the processed authentication face image DB 323. Then, if an affirmative determination is made in step S201, the processed authentication face image, which is associated with the user ID and stored in the processed authentication face image DB 323, may be read, and thereafter, the processing in steps S207 and S208 may be performed.

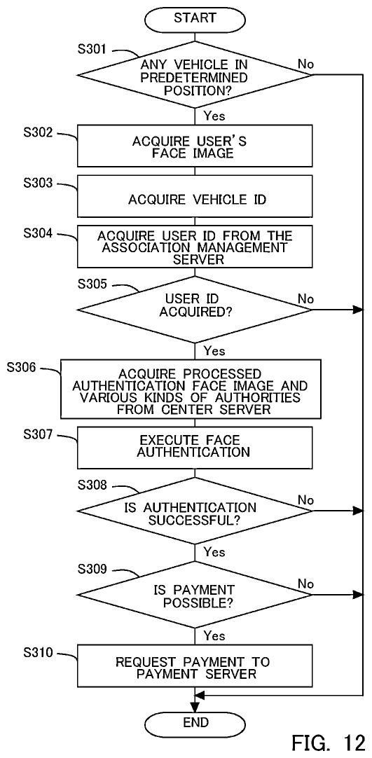

Next, the face authentication processing in the user side server 40 will be described. FIG. 12 is a flowchart of the face authentication processing in the user side server 40 according to the embodiment. The processing illustrated in FIG. 12 is carried out in the user side server 40 at predetermined time intervals. Note that the processing illustrated in FIG. 12 is performed by each software module of the control unit 41, but in the following flowchart, description will be given assuming that the control unit 41 performs the processing.

In step S301, the control unit 41 determines whether or not the vehicle 10 is present at a predetermined position. The predetermined position is, for example, a position at which an item is ordered or a position at which an item is received in a drive-through. Note that the predetermined position is not limited to a position at which the vehicle 10 stops, but may be a position through which the vehicle 10 passes during traveling. In addition, the predetermined position is a position where the camera 400 can capture the face of the driver of the vehicle 10. When an affirmative determination is made in step S301, the processing or routine proceeds to step S302, whereas when a negative determination is made, this routine is ended.

In step S302, the control unit 41 acquires a user's face image by capturing the driver of the vehicle 10 with the camera 400. The control unit 41 stores the user's face image thus acquired in the storage unit 42. In step S303, the control unit 41 acquires the vehicle ID from the vehicle 10. For example, the vehicle ID may be transmitted from the in-vehicle device 100 to the camera 400 using short-range wireless communication. As another example, the camera 400 may capture a license plate of the vehicle 10 to acquire the vehicle number by image analysis.

In step S304, the control unit 41 acquires the user ID corresponding to the vehicle ID from the association management server 50. At this time, the control unit 41 inquires of the association management server 50 whether or not a valid association relationship corresponding to the vehicle ID exists at a target date and time. In this case, the control unit 41 transmits information on the vehicle ID and the target date and time to the association management server 50. For example, if the user has not registered a user ID, there is no valid association relationship corresponding to the vehicle ID. Therefore, in the association management server 50, it is determined whether or not there is a user ID corresponding to the vehicle ID. Also, for example, an expiration date may be set for the association between the vehicle ID and the user ID. In this case, if the expiration date of the association between the vehicle ID and the user ID has passed, there is no valid association relationship corresponding to the vehicle ID. Therefore, in the association management server 50, it is determined whether or not the association between the vehicle ID and the user ID is within the expiration date. For example, when a valid association relationship between the vehicle ID and the user ID is required at a specific date and time, a time stamp is used to determine whether or not a valid association relationship between the vehicle ID and the user ID exists at that specific date and time. When a valid association relationship between the vehicle ID and the user ID exists at the target date and time, the association management server 50 transmits the user ID to the user side server 40. On the other hand, when there is no valid association relationship between the vehicle ID and the user ID at the target date and time, the association management server 50 sends information to that effect to the user side server 40. In this case, the control unit 41 cannot acquire the user ID corresponding to the vehicle ID.

In step S305, the control unit 41 determines whether or not the user ID has been acquired in step S304. When an affirmative determination is made in step S305, the processing or routine proceeds to step S306, whereas when a negative determination is made, this routine is ended. Note that when a negative determination is made in step S305, the user may be notified that payment cannot be made. In this case, the user side server 40 may be configured, for example, to display a signage to that effect or play a sound from a speaker to that effect.

In step S306, the control unit 41 acquires the processed authentication face image and information on the various kinds of authorities from the center server 30. At this time, the control unit 41 transmits a request for a search by the user ID to the center server 30. In response to this request, the center server 30 transmits the processed authentication face image and information on the various kinds of authorities of the user to the user side server 40. Then, the control unit 41 receives the processed authentication face image and information on the various kinds of authorities of the user from the center server 30.

In step S307, the control unit 41 performs face authentication by comparing the user's face image acquired in step S302 with the processed authentication face image acquired in step S306. Known techniques can be employed for the face authentication. The method of face authentication is not particularly limited, and may be determined as appropriate according to its implementation.

In step S308, the control unit 41 determines whether or not the face authentication is successful. When an affirmative determination is made in step S308, the processing or routine proceeds to step S309, whereas when a negative determination is made, this routine is ended. Note that when a negative determination is made in step S308, the user may be notified that payment cannot be made.

In step S309, the control unit 41 determines whether or not the user can make a payment at the payment server 70. The control unit 41 determines whether or not the user's authority for payment is valid based on the information on the various kinds of authorities acquired from the center server 30. In this case, the control unit 41 may inquire of the payment server 70 whether or not the user can make a payment at the payment server 70. When an affirmative determination is made in step S308, the processing or routine proceeds to step S310, whereas when a negative determination is made, this routine is ended.

In step S309, the control unit 41 requests the payment server 70 to make a payment. That is, the user's authority is executed. At this time, the user ID and information on an amount of money to be paid are transmitted to the payment server 70.

In this way, the attribute of the vehicle 10 is reflected in the processed authentication face image. Therefore, it is possible to suppress the discrepancy between the appearance of the user in the user's face image obtained at the time of authentication and the appearance of the user in the processed authentication face image. Accordingly, it is possible to improve the accuracy of face authentication of the user who is still in the vehicle 10.

### Second Embodiment

In the present embodiment, in cases where a plurality of vehicle IDs of the same vehicle type are associated with the same user ID, a processed authentication face image that has already been generated is diverted. Specifically, even in the case where a vehicle 10 is assigned a vehicle ID different from that of another vehicle 10 for which a processed authentication face image has already been generated, the already generated processed authentication face image can be diverted if the vehicle 10 is of the same vehicle type. In other words, if the vehicle type is the same, it is considered that the attribute of the vehicle 10 has a similar effect on the user's face image, and hence, if the vehicle type and the user ID are the same, it is possible to divert the processed authentication face image.

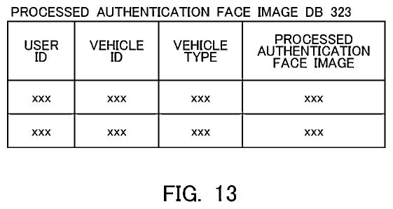

When generating a processed authentication face image and storing it in the processed authentication face image DB 323, the face image processing unit 314 of the center server 30 stores the processed authentication face image in association with the user ID, the vehicle ID, and the vehicle type. Here, FIG. 13 is a view illustrating an example of a table configuration of the processed authentication face image DB 323 according to a second embodiment. The relationships among user IDs, vehicle IDs, vehicle types, and processed authentication face images are stored in the processed authentication face image DB 323. The information on the vehicle type is included in the information acquired by the vehicle information acquisition unit 313 from the vehicle ID server 60.

In addition, the face image processing unit 314 of the center server 30 determines, before generating a processed authentication face image, whether or not a record with the same user ID and the same vehicle ID as in the processed authentication face image already exists in the processed authentication face image DB 323. Then, when there is no record with the same user ID and the same vehicle type, the face image processing unit 314 of the center server 30 generates a processed authentication face image based on the vehicle attribute. On the other hand, when there is a record with the same user ID and the same vehicle type, the face image processing unit 314 extracts a processed authentication face image stored in the record with the same user ID and the same vehicle type. Then, the processed authentication face image thus extracted is stored in the processed authentication face image DB 323 in association with the user ID, the vehicle ID, and the vehicle type. In this way, if a processed authentication face image has already been generated for a vehicle 10 with the same user ID and the same vehicle type, the processed authentication face image is diverted instead of subsequently generating a new processed authentication face image for a vehicle 10 with the same user ID and the same vehicle type.

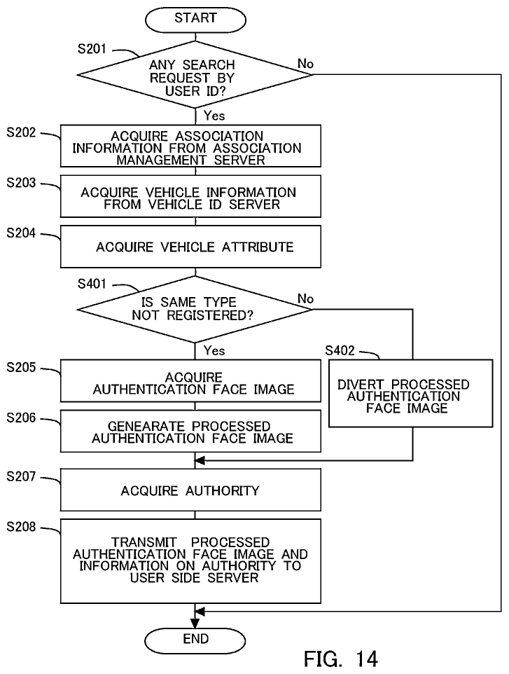

Hereafter, a description will be given of the processing of providing the processed authentication face image in the center server 30. FIG. 14 is a flowchart of the processing for providing the processed authentication face image in the center server 30 according to the second embodiment. The processing illustrated in FIG. 14 is carried out in the center server 30 at predetermined time intervals. Note that the processing illustrated in FIG. 14 is performed by each software module of the control unit 31, but in the following flowchart, description will be given assuming that the control unit 31 performs the processing. Here, note that steps in which the same processing as in FIG. 11 is performed will be denoted by the same reference signs, and the description thereof will be omitted.

In the routine illustrated in FIG. 14, when the processing of step S204 is completed, the routine proceeds to step S401. In step S401, the control unit 31 determines whether the same vehicle type for the user ID acquired in step S201 is not registered in the processed authentication face image DB 323. In other words, the control unit 31 determines whether a record with the same user ID and the same vehicle type does not exist in the processed authentication face image DB 323. When an affirmative determination is made in step S401, the routine proceeds to step S205, whereas when a negative determination is made, the routine proceeds to step S402.

In step S402, the control unit 31 diverts the processed authentication face image. At this time, the control unit 31 extracts the processed authentication face image from the record with the same user ID and the same vehicle type. The control unit 31 associates the processed authentication face image thus extracted with the user ID, the vehicle ID, and the vehicle type, and stores it in the processed authentication face image DB 323. Note that as another example, information on a location where the processed authentication face image extracted is stored may be associated with the user ID, the vehicle ID, and the vehicle type and stored in the processed authentication face image DB 323.

In this way, the processed authentication face image can be diverted to reduce the load on the center server 30.

### Other Embodiments

The above-described embodiments are merely examples, but the present disclosure can be implemented with appropriate modifications without departing from the spirit thereof. The processing and/or means (devices, units, etc.) described in the present disclosure can be freely combined and implemented as long as no technical contradiction occurs. In addition, the processing described as being performed by one device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system.

For example, one server may have the functions of two or more servers among the center server 30, the user side server 40, the association management server 50, the vehicle ID server 60, and the payment server 70. For example, the center server 30 and the user side server 40 may be a single server. Similarly, the center server 30 and the association management server 50 or the vehicle ID server 60 may be a single server.

In addition, the processed authentication face image generated by the center server 30 may be transmitted from the center server 30 to the user side server 40 and stored in the storage unit 42 of the user side server 40 before a request for a search by the user ID is made by the user side server 40.

Further, the processed authentication face image may be generated by the control unit 41 of the user side server 40. In this case, a request is sent to the center server 30 to transmit the authentication face image at the time of user registration, which is necessary for generating the processed authentication face image. At this time, information on at least one of the user ID and the vehicle ID is transmitted to the center server 30. In addition, the authentication face image and information on the various kinds of authorities of the user and information on the attributes of the vehicle 10 are also acquired from the center server 30. Note that the information on the attributes of the vehicle 10 may be directly acquired by the control unit 41 from the vehicle ID server 60. The control unit 41 generates a processed authentication face image based on the authentication face image received from the center server 30 and the attributes of the vehicle.

Moreover, the control unit 31 of the center server 30 may periodically access the association management server 50 to generate a processed authentication face image for each vehicle type corresponding to the user ID. This makes it possible to handle cases such as when a user changes vehicles 10 or purchases an additional vehicle 10.

In the above-described embodiments, payment is requested to the payment server 70 when face authentication is successful, but the user side server 40 can execute the various kinds of authorities of the user without being limited to payment.

In addition, upon generation of the processed authentication face image, the height at which the camera 400 is placed may be reflected. Since the angle of the user's face changes depending on the height at which the camera 400 is placed, the authentication face image may be processed so that the user is facing forward, for example. The vehicle height may be used as an attribute of the vehicle 10. In this case, the processed authentication face image may be generated so that the angle of the face is changed according to the vehicle height.

The present disclosure can also be implemented by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. A computer networking apparatus including a controller configured to perform:
acquiring a data of a user of a vehicle and an image of a face of the user;
acquiring a data of the vehicle associated with the data of the user;
acquiring a data of an attribute of the vehicle associated with the data of the vehicle; and
generating a second image by processing the image according to the data of the attribute of the vehicle.

2. An information processing apparatus including a controller configured to perform:
acquiring user identification information that is identification information of a user of a vehicle and an authentication face image that is an image of a face of the user for authentication;
acquiring vehicle identification information that is identification information of the vehicle associated with the user identification information;
acquiring information on an attribute of the vehicle associated with the vehicle identification information; and
generating a processed authentication face image by processing the authentication face image according to the information on the attribute of the vehicle.

3. The information processing apparatus according to claim 2, wherein the controller stores the processed authentication face image in a memory so as to be usable for face authentication when the user uses the vehicle.

4. The information processing apparatus according to claim 1, wherein the controller acquires the user identification information and the authentication face image from a terminal of the user.

5. The information processing apparatus according to claim 2, wherein the controller transmits the processed authentication face image corresponding to the user identification information in response to a request for transmission of the processed authentication face image corresponding to the user identification information.

6. The information processing apparatus according to claim 2, wherein the controller generates the processed authentication face image in response to a request for transmission of the processed authentication face image corresponding to the user identification information.

7. The information processing apparatus according to claim 2, wherein the controller generates the processed authentication face image in response to acquisition of the user identification information and the authentication face image from a terminal of the user.

8. The information processing apparatus according to claim 2, wherein the controller generates the processed authentication face image by reflecting a color of a glass of the vehicle.

9. The information processing apparatus according to claim 2, wherein the controller generates the processed authentication face image by processing the authentication face image as an image captured through a glass of the vehicle according to the information on the attribute of the vehicle.

10. The information processing apparatus according to claim 2, wherein the controller further performs:
acquiring information on a vehicle type associated with the vehicle identification information;
storing, in response to generation of the processed authentication face image, the processed authentication face image in a memory in association with the user identification information and the information on the vehicle type; and
generating, in response to acquisition of the information on the vehicle type, the processed authentication face image when a first processed authentication face image with the same user identification information and the same information on the vehicle type associated with the processed authentication face image is not stored in the memory; and
associating, in response to acquisition of the information on the vehicle type, the first processed authentication face image with the information on the vehicle type and the user identification information, instead of generating the processed authentication face image, when the first processed authentication face image is stored in the memory.

11. An information processing method for causing a computer to perform:
acquiring user identification information that is identification information of a user of a vehicle and an authentication face image that is an image of a face of the user for authentication;
acquiring vehicle identification information that is identification information of the vehicle associated with the user identification information;
acquiring information on an attribute of the vehicle associated with the vehicle identification information; and
generating a processed authentication face image by processing the authentication face image according to the information on the attribute of the vehicle.

12. The information processing method according to claim 11, further causing the computer to store the processed authentication face image in the memory so as to be usable for face authentication when the user uses the vehicle.

13. The information processing method according to claim 11, further causing the computer to acquire the user identification information and the authentication face image from a terminal of the user.

14. The information processing method according to claim 11, further causing the computer to transmit the processed authentication face image corresponding to the user identification information in response to a request for transmission of the processed authentication face image corresponding to the user identification information.

15. The information processing method according to claim 11, further causing the computer to generate processed authentication face image corresponding to the user identification information in response to a request for transmission of the processed authentication face image corresponding to the user identification information.

16. The information processing method according to claim 11, further causing the computer to generate the processed authentication face image in response to acquisition of the user identification information and the authentication face image from a terminal of the user.

17. The information processing method according to claim 11, further causing the computer to generate the processed authentication face image by reflecting a color of a glass of the vehicle.

18. The information processing method according to claim 11, further causing the computer to generate the processed authentication face image by processing the authentication face image as an image captured through a glass of the vehicle according to the information on the attribute of the vehicle.

19. The information processing method according to claim 11, further causing the computer to perform:
acquiring information on a vehicle type associated with the vehicle identification information;
storing, in response to generation of the processed authentication face image, the processed authentication face image in a memory in association with the user identification information and the information on the vehicle type; and
generating, in response to acquisition of the information on the vehicle type, the processed authentication face image when a first processed authentication face image with the same user identification information and the same information on the vehicle type associated with the processed authentication face image is not stored in the memory; and
associating, in response to acquisition of the information on the vehicle type, the first processed authentication face image with the information on the vehicle type and the user identification information, instead of generating the processed authentication face image, when the first processed authentication face image is stored in the memory.
